(19) United States
(12) Patent Application Publication
(10) Pub. No.: US 2024/0259458 A1
(43) Pub. Date: Aug. 1, 2024

(54) COMPUTER-IMPLEMENTED METHOD FOR SHARING A DATA STREAM DISPLAYED ON A DISPLAY OF A FIRST CLIENT, AND COMMUNICATION AND COLLABORATION PLATFORM

(71) Applicant: Unify Patente GmbH & Co. KG, München (DE)

(72) Inventor: Stefan Moers, Baesweiler (DE)

(21) Appl. No.: 17/296,615

(22) PCT Filed: Nov. 27, 2018
(86) PCT No.: PCT/EP2018/082745

§ 371 Date: Oct. 4, 2021

(51) Int. Cl. H04L 65/80; G06F 3/04842; G06F 3/14; H04L 65/403; H04L 65/613; H04L 65/65

(52) U.S. Cl. CPC H04L 65/80; G06F 3/04842; G06F 3/1454; H04L 65/403; H04L 65/613; H04L 65/65

(57) ABSTRACT

A method for sharing a data stream on a display of a first client with at least one second client in a network system with a central media server can include receiving video and/or image data to be shared which is transmitted by the first client and is displayed on the first client; forwarding the video and/or image data from the central media server to the second client, and receiving, on the media server, first data which describes a first selection area from an image generated from the video and/or image data. The first selection area can be cut out of the video and image data to be shared; and the first selection area can be transmitted to the at least one second client.

### CROSS-REFERENCE TO RELATED APPLICATIONS

This application is the U.S. national stage application of International Patent Application No. PCT/EP2018/082745, which was filed on Nov. 27, 2018.

### FIELD

This invention concerns a computer-implemented method for sharing a data stream comprising video and/or image data displayed on a display of a first client as well as a communication and collaboration platform for carrying out the method.

### BACKGROUND

In the prior art, communication and collaboration systems and/or platforms are known that allow the users to have real-time conferences with a number of participants that are in different locations.

When doing so, in the context of a web collaboration using one of the above-named communication and collaboration platforms, often a participant of such a real-time conference shares a document or the content of his screen on the client of the other participants (screen sharing), wherein the contents of the document are initially sent in the form of video data streams to a central server of the communication and collaboration platform, which forwards the video data streams to the other participants of the real-time conference or their client, via which they are participating in the conference.

### SUMMARY

In the prior art, it is usual to transmit the contents of the shared screen or a displayed document on it by a participant in its full resolution to the other clients and to display it there in the full transmitted resolution on each respective display of the other client.

As the resolutions of today's screens are increasing ever higher—for example, screens with 4K resolution are nearly standard and 8K screens are already being used—a real-time transfer in full resolution is problematic for the bandwidth required for this transmission. This also requires a high computing capacity, which then especially leads to problems if the other participants are participating with tablets or smartphones as clients in the real-time conference, whose displays have significantly lower resolutions. But even with the common displays that have high resolution, the documents that come from a large 4K or 8K screen are not displayed legibly on what are normally much smaller displays.

To improve the legibility in such cases, it is known from the prior art to enlarge a transferred image, for example a text page of a document, using a zoom function. Nevertheless, in this case as well, the full image is transferred although only a part of it is needed. This means much bandwidth is used unnecessarily for the transfer of the full image, from which only a small section will be viewed or can be viewed.

Therefore, it would be preferable to reduce the transfer quantity and therefore the required bandwidth if the viewing of a full image is not possible or desired, for example, due to a lower resolution or a too small display at the terminal. Therefore, it is an object of the present invention to provide a computer-implemented method for sharing a data stream comprising video and/or image data displayed on a display of a first client as well as a communication and collaboration platform for carrying out the method, by means of which content to be transferred is easily legible on a lower-resolution display, in doing so simultaneously achieving a reduction in the bandwidth required for the transfer of the content to be displayed.

A computer-implemented method for sharing a data stream on a display of a first client with at least one second client in a network system with a central media server, via which the first client and the second client communicate with each other, is provided, wherein the method comprises the following steps: receiving, on the media server, video and/or image data to be shared which is transmitted by the first client and is displayed on the first client; forwarding the video and/or image data from the central media server to the second client, wherein the second client receives the video and/or image data, the received video and/or image data is displayed on a display of the second client, and a first selection area is determined on the second client from the image generated from the video and/or image data; receiving, on the media server, first data which describes the first selection area from the image generated from the video and/or image data; cutting the first selection area out of the video and image data to be shared; and transmitting the first selection area to the at least one second client.

Embodiments of the invented method can transfer only the video and/or image data or desired portion of data required by the recipient according to a selection area specified at the second client, which on the one hand advantageously reduces the bandwidth requirements for the transfer of the video and/or image data. On the other hand, only the portion of data of interest to the second client is transferred and displayed, so that even if the second client is equipped only with a small display or with a lower-resolution display, the portion in the selection area is displayed well and is easily legible to the user. Therefore, only the required information is transferred and not the full video and/or image data, whereby the user can define which section or selection area is of interest to him and is to be processed accordingly to then transfer and display it on his display, for example, i.e., the display of the second client.

The first data, in which the first selection area is described, preferably comprise the relative size and position of the first selection area.

The method according to a preferred embodiment furthermore comprises the step of forwarding the first data from the media server to the first client. The media server can include a computer device that includes a processor connected to a non-transitory computer readable medium.

According to a further preferred embodiment, the first data that describes the selection area is sent by the second client to the media server via an RTP data channel.

According to yet another preferred embodiment, the media server forwards the first data that describes the selection area to the first client via an RTP data channel.

The media server preferably receives the encoded image and/or video data from the first client for the first selection area and forwards the image and/or video data to the second client. This also reduces the bandwidth required for sending the video and/or image data from the sending and sharing first client to the media server.

In addition, it is advantageous if the media server processes and forwards the image and/or video data to be shared by the first client to the second client according to the first data, which describes the first selection area. According to yet another preferred embodiment, the media server receives second data from the second client that describes a second selection area from the image and/or video data to be shared.

According to a further preferred embodiment, the method concerns a real-time conference on a web-based communication and collaboration platform, in which content which is displayed on the display on the first client is shareable via screen sharing with at least the second client.

The display on the first client preferably has a higher resolution than the display at the second client. The first client can include a computer device that includes a processor connected to a non-transitory computer readable medium. The second client can include a computer device that includes a processor connected to a non-transitory computer readable medium.

The method may furthermore comprise the following steps: Receiving data from a third party on the media server, that describes a third selection area from the image and/or video data to be shared from a third client in real-time, wherein the third selection area received from the third client is different from the first selection area received from the second client, processing of the image and/or video data to be shared according to the third party data; and forwarding of the processed image and/or video data on the third client. As each client or each user of an additional client in the communication and collaboration platform has the option to individually define a selection area that is especially of interest to him or especially suitable for his display or system requirements, the overall bandwidth required for sharing of contents on the communication and collaboration platform is advantageously reduced.

In addition, a collaboration and conversation platform with a central media server and a number of clients, which communicate with one another via a network, is provided for carrying out a computer-implemented method for sharing a data stream comprising video and/or image data on a first display of a first client.

Other details, objects, and advantages of the method, communication and collaboration platform, a communication system, a communication device, and methods of making and using the same will become apparent as the following description of certain exemplary embodiments thereof proceeds.

### BRIEF DESCRIPTION OF THE DRAWINGS

The invention and its embodiments are described in detail below in connection with the drawing, in which:

FIG. 1 shows a schematic diagram of screen sharing on a communication and collaboration platform;

FIG. 2 schematic definition of a first selection area on a second client;

FIG. 3 schematic diagram of screen sharing according to a first selection area on the second client;

FIG. 4 schematic diagram of screen sharing according to a second selection area on the second client; and

FIG. 5 schematic diagram of screen sharing with multiple clients and different selection areas.

Reference numerals used in the drawings include:
1 Communication and collaboration platform
2 Media server
3 Communication network
4 First client
5 Second client
6, 6′, 6″ Video channels
7, 7′, 7′″ Data channels
8 First display
9 Second display
10 Content to be shared
11 First selection area
12 First data
13 Second selection area
14 Third client
15 Third selection area
16 Second data

### DETAILED DESCRIPTION

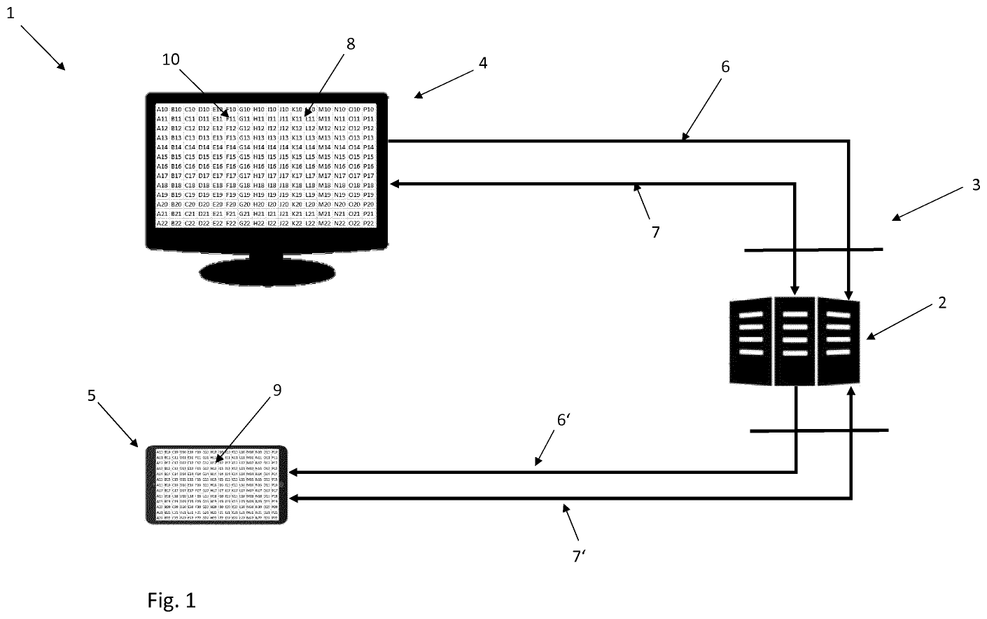

FIG. 1 shows a schematic diagram of a web real-time communication (WebRTC) communication and collaboration platform 1 according to one embodiment, that is arranged for example for the carrying out of real-time conferences with a number of participants found in different locations. A central media server 2 is provided for this purpose, which communicates via a communication network 3 with a first client 4 and a second client 5 via the RTP-video channels 6, 6′ shown here and the RTP data channels 7, 7′. In the process, the first client 4 is connected with the central media server 2 via a first video channel 6 and a first RTP data channel 7 and the second client 5 is connected with the central media server 2 via a second video channel 6′ and a second RTP data channel 7′. Each client 4, 5 is equipped with an own display. In the embodiment shown here, the first client 4 has a first display 8 that has a high resolution, e.g. a 4K resolution. On the first display 8, a content 10 to be shared, for example a document to be shared or the like, is displayed in higher resolution. To share this content 10, the first client 4 sends corresponding image or video data in the form of an RTP data stream via the first RTP video channel 6 to the central media server 2. The central media server 2 forwards the RTP data steam received from the first client 4 to the second client 5. This, however, has a display (described here as second display) 9 in the embodiment shown here that has a significantly lower resolution than the display of the first client 4. For example, the second display 9 may be a full HD display, which only has 4 of the resolution of the first display 8. Therefore, when showing the image or video data from the first client 4 via the central media server 2 to the second client 5, these are no longer legible on the second display 9 for the user of the second client 5.

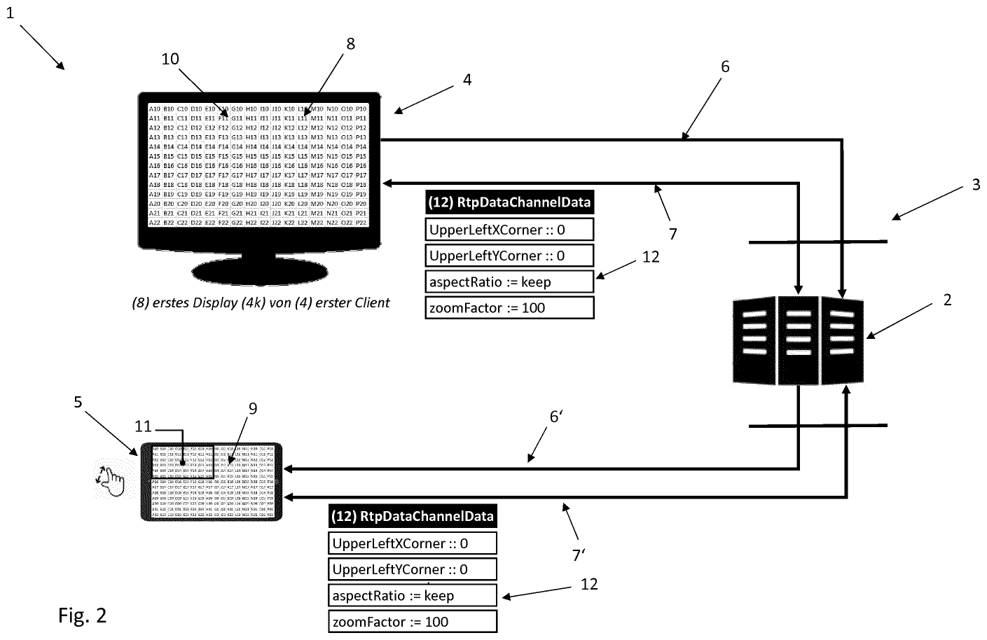

FIG. 2 schematically shows the definition of a first selection area 11 on the second client 5 or on its display 9. The first selection area 11 shows a section of the shared content shown that was captured by the first client 4, which is of interest to the user of the second client 5. The definition of the first selection area 11 can be done in such a way that the user uses a zoom function, which sets the limits of the first selection area 11. For example, in the event that the second client 5 is a tablet, zooming on its touchscreen would be usable to define the first selection area 11. In the process, the user, while maintaining the aspect ratio selects an area of the image or content shown on display 9.

After the selection process is completed, as described above, the first data 12, which describes the so-defined first selection area 11, i.e., its size and its position, is transferred via the second RTP data channel 7′ by the second client 5 to the central media server 2. Here the first data 12 is represented with “upperLeftXCorner” and “upperLeftYCorner”; these describe the position of the upper left corner of the new section or the first selection area 11. The details are relative, i.e., as a percent of the total width and total height of the image or content displayed on display 9.

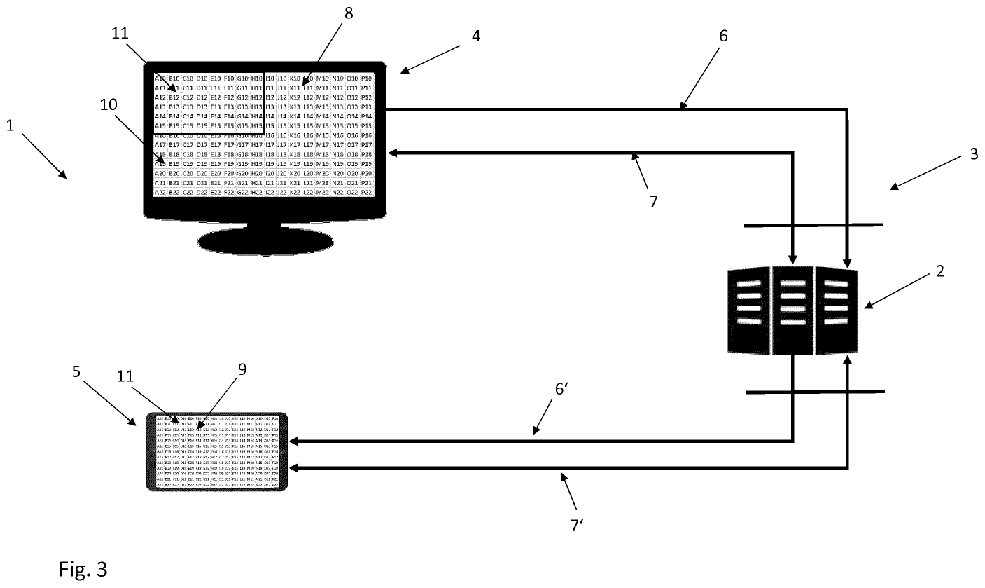

The first data 12 received by the central media server 2 are then forwarded to the first client 4 via the first RTP data channel 7, so that it knows which section or selection area of the second client 5 or its user is being viewed at that moment. According to one embodiment, this first selection area 11 can also additionally be displayed on the first display 8 of the first client 4 (see FIG. 3).

FIG. 3 shows a schematic diagram of screen sharing according to a first selection area 11 on the second client 5. After receipt of the first data 12, which describes the first selection area 11, which was defined on the second client 5, the first client 4 sends the content shown on the first display 8 of the first client 4 again completely to the central media server 2, as already described via the first RTP video channel 6 in the form of an RTP data stream. The central media server 2 decodes the image or the image data shown of the RTP data stream received and cuts out the first selection area 12 defined by the second client 5 from the entire image and processes the new image data or the image data reduced in such a way for the second client 5 accordingly.

According to an alternative embodiment, the first client 4 may also only encode and forward the image data for the first selection area 11 to the central media server 2 via the first RTP video channel 6 instead of the entire image, as previously described, which advantageously reduces the bandwidth requirements for the transfer of the RTP data stream by the first client 5 to the central media server 2. However, in this case, the first selection area 12 must have already been cut out from the image data on the first client 4. This could be realized, for example, by means of a Chrome Desktop Capture API, which expands the option to capture any image sections. However, if the source sharing content is not a browser that executes a desktop screen sharing, but rather, for example, a camera, which exchanges image data with a web server, then the web server must clip out the corresponding section or selection area from the image.

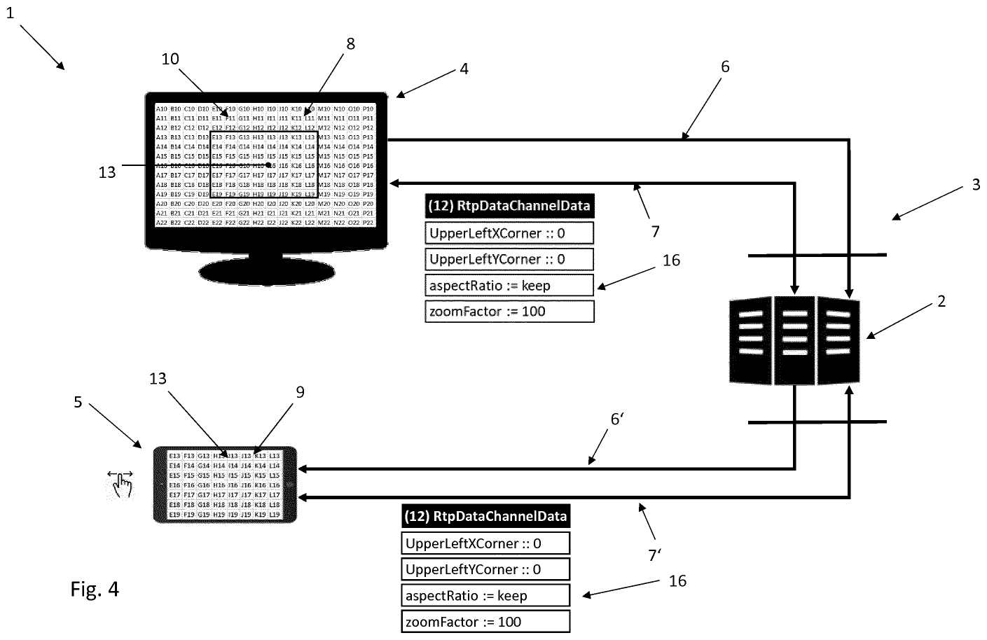

FIG. 4 shows a schematic diagram of screen sharing according to a second selection area 13 on the second client 5. If the user would like to view another selection area on the second client 5, then he can simply define a new second selection area 13, as already described in connection with the definition of the first selection area 11. If the second selection area 13 has been so defined, then second data 16, which describes the new position and size of the second selection area 13, is sent by the second client 5 to the central media server 2, which forwards this in turn to the first client 4. The processing of the reduced image data then occurs as already described in connection with FIG. 2 and FIG. 3.

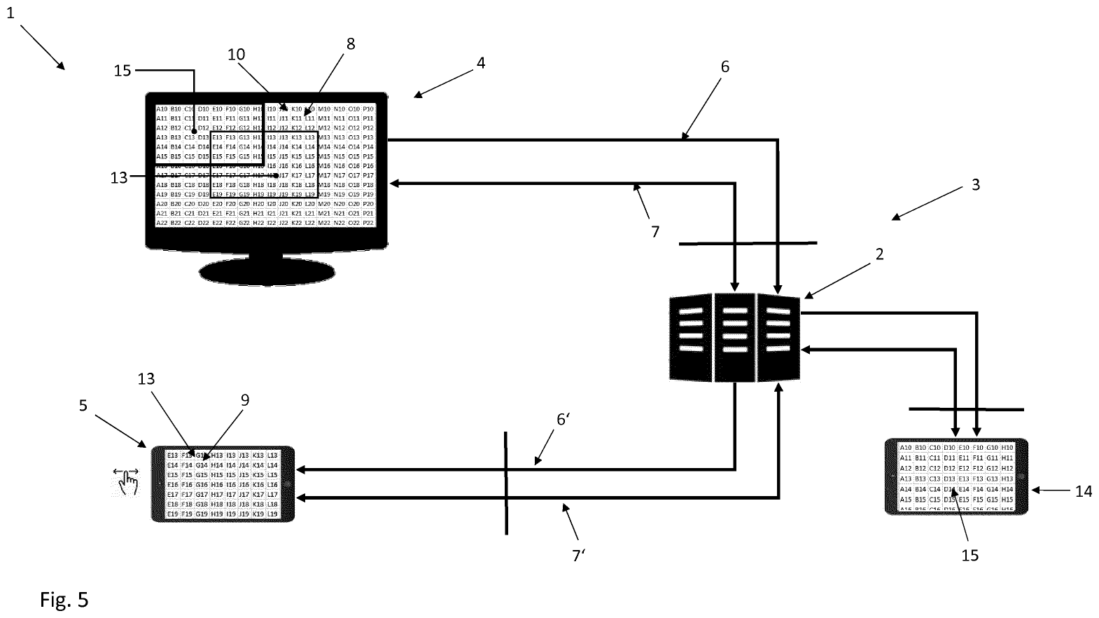

FIG. 5 shows a schematic diagram of screen sharing with multiple clients and different selection areas, i.e. the second client 5 defines a first selection area 11, for which the corresponding image data are transferred and a third client 14, which is connected via a third video channel 6″ RTP video and a third RTP data channel 7″ with the media server 2, defines a third selection area 15, for which the corresponding image data are to be transferred, and which differs with regard to at least its position in reference to the starting image, i.e. the content to be shared, sent by the first client 4.

Here also, the first data 12, which describe the first selection area 11, and the third data, which describe the third selection area 15, are delivered via the respective RTP channels 7′, 7″ on the central media server 2, which then processes them corresponding to the already previously described processes on the first client 4 or corresponding to the reduced form for the respective second and third clients 5, 14, so that they can be shown legibly on the respective display for the respective user. It is also not strictly required here that the first client 4 transmit the entire video and/or image data to the central media server 2 in a further step, which then generates the corresponding selection areas 13, 15 and forwards to second and third client 5, 14 accordingly, rather it is possible that the first client 4 solely forward the respective video and/or image data corresponding to the respective defined selection areas 11, 15 to the central media server 2, to reduce the bandwidth requirements for transfer to the RTP data streams.

As already described above, the user/users are allowed to define a desired section of the content or image/video to be shared in real-time using the above-described method according to the embodiments shown, wherein this information is transmitted to the sharing client in real-time. The reduced contents or images alone are then processed and transmitted to the client defining this desired section, which advantageously reduces the bandwidth requirements. A zooming or shifting of a section or selection area in real-time is possible. As soon as the user changes the image section in any way, this is communicated to the central media server in real-time via the respective RTP data channel. This can then encode the new selection area immediately and send it to the corresponding client.

In this way, as already mentioned, transferring only the required information.

The above-described method is not only suitable for sharing of screen contents within a real-time conference, as described above in the exemplary embodiments, but also for the following applications. For example, a high-resolution security camera can provide an image which is viewed by one or more users. Then it is possible here to zoom in the high resolution image and each user can view another image section or selection area.

Also for applications in which X-ray scans are to be shared, for example, of materials or components, or images from imaging procedures in medical technology or complex CAD drawings, the method is advantageous. The corresponding image data are ready for delivery on demand on a media server and a user may, for example, by a WebRTC-based client, retrieve this image data in suitable and desired sections or selection area and may freely move by shifting or zooming in the images shown. In all of the cases explained above, the respective user in any case defines which image section of the central media server is to be processed and transmitted for him in real-time on his client.

While certain exemplary embodiments of a method of telecommunication, a telecommunication apparatus, telecommunication device, terminal device, a communication system, media server, collaboration system, and methods of making and using the same have been shown and described above, it is to be distinctly understood that the invention is not limited thereto but may be otherwise variously embodied and practiced within the scope of the following claims.

1-13. (canceled)

14. A computer-implemented method for sharing a data stream displayed on a display of a first client with at least one second client that communicate with each other via a communication network that comprises a central media server, the method comprising:
receiving, on the media server, video and/or image data to be shared which is transmitted by the first client and is displayed on the first client,
forwarding the video and/or image data from the central media server to the second client, wherein the second client receives the video and/or image data, the received video and/or image data is displayed on a display of the second client, and a first selection area is determined on the second client from the image generated from the video and/or image data;
receiving, on the media server, first data which describes the first selection area from the image generated from the video and/or image data;
cutting the first selection area out of the video and image data to be shared; and
transmitting the first selection area to the at least one second client.

15. The method of claim 14, wherein the first data that describes the first selection area comprises the relative size and position of the first selection area.

16. The method of claim 14, wherein the method comprises forwarding the first data from the media server to the first client.

17. The method of claim 14, wherein the first data that describes the first selection area is sent by the second client via a second RTP data channel to the media server.

18. The method of claim 14, wherein the media server forwards the first data that describes the first selection area to the first client via a first RTP data channel.

19. The method of claim 14, wherein the media server receives encoded image and/or video data from the first client for the first selection area and forwards them to the second client.

20. The method of claim 14, wherein the media server processes and forwards the image and/or video data to be shared by the first client to the second client according to the first data that describes the first selection area.

21. The method of claim 14, wherein the media server receives second data from the second client that describes a second selection area from the image and/or video data to be shared.

22. The method of claim 14, wherein the method is performed in a real-time conference on a web-based communication and collaboration platform, in which content displayed on the display on the first client is shareable via screen sharing with the at least the second client.

23. Computer-implemented method according to claim 22, wherein the display on the first client has a higher resolution than the display on the second client.

24. The method of claim 14, wherein the method comprises:
receiving, on the media server third data that describes a third selection area from the image and/or video data to be shared from a third client in real-time, wherein the third selection area received from the third client is different from the first selection area received from the second client,
processing of the image and/or video data to be shared according to the third data; and
forwarding of the processed image and/or video data on the third client.

25. The method of claim 14, wherein the data stream comprises video and/or image data, which is displayed on a display of the first client.

26. A collaboration and conversation platform with a central media server communicatively connectable to a number of clients which communicate with one another via a communication network for carrying out a computer-implemented method for sharing a data stream which comprises video and/or image data displayed on a first display of a first client according to claim 14.

27. A collaboration and conversation platform comprising:
a central media server comprising a processor connected to a non-transitory computer readable medium, the central media server communicatively connectable to a plurality of clients that includes a first client and a second client;
the central media server configured to receive, via the communication network, video and/or image data to be shared which is transmittable by the first client and is displayable on the first client;
the central media server configured to forward the video and/or image data from the central media server to the second client such that the video and/or image data is receivable at the second client and is displayable on a display of the second client, and a first selection area is determinable on the second client from the image generated from the video and/or image data; and
the central media server configured to receive first data which describes the first selection area from the image generated from the video and/or image data, cut the first selection area out of the video and image data to be share and transmit the first selection area to the second client.
